(19) United States
(12) Patent Application Publication
(10) Pub. No.: US 2004/0205027 A1
(43) Pub. Date: Oct. 14, 2004

(54) Download redemption system

(76) Inventor: John Vidor, Santa Monica, CA (US)

Correspondence Address: JOHN VIDOR, 944 9th ST. #7, SANTA MONICA, CA, 90403, US

(21) Appl. No.: 10/751,733

(22) Filed: Dec. 31, 2003

Related U.S. Application Data
(60) Provisional application No. 60/437,580, filed on Dec. 31, 2002.

(51) Int. Cl. H04K 1/00; H04L 9/00; G06F 17/60; G06F 15/16

(52) U.S. Cl. 705/52; 709/201

(57) ABSTRACT

A process which enables holders of copyrighted files to be compensated and also for an individual who downloads such copyrighted material to be exonerated from civil and criminal liability. After one or more acts of downloading by the individual, a third party uses various means to acquire data which identifies files downloaded by the individual, subsequently charges a predetermed fee from the individual, and disperses revenues in a predetermined manner.

### CROSS-REFERENCE TO RELATED APPLICATION

This Application claims the benefit of Provisional Application Ser. No. 60/437,580 filed 2002 Dec. 31.

### FEDERALLY SPONSORED RESEARCH

None

### BACKGROUND OF THE INVENTION

1. Field of Invention

This invention relates generally to individuals downloading files through the Internet, and particularly to a method of accounting for such downloading.

2. Prior Art

Internet websites such as Kazaa.com, Gnutella.com, LimeWire.com, DirectConnect.com, all allow and facilitate, free of charge, individuals to download files which contain copyrighted content. There has heretofore been no method for copyright holders of such content to receive compensation for these acts from such free services.

Additionally, fee-based online services such as MusicNet.com, iTunes.com, Rhapsody.com, BuyMusic.com, and PressPlay.com, all implement pay receptions, where a charge occurs prior to the downloading of each file transferred. Individuals who make a purchase in this manner subsequently receive copyrighted files, and thus, such systems compensate the appropriate copyright holders. However, each of these fee-based systems has a predetermined and limited body of files from which to choose and which can be downloaded. In other words, these legitimate services don't allow unlimited searching of the entire Internet for file titles. Also, these legitimate services require the individual music (or motion picture) buyer to spend time and energy identifying themselves and making a purchase prior to each download action.

### OBJECTS AND ADVANTAGES

Accordingly several objects and advantages of the present invention are as follows: To provide an improved method for individuals having downloaded copyrighted files from the Internet, to compensate the copyright owners of such files, and to allow such downloads without the individuals having to pay prior to downloading. Still further objects will become apparent from implementation of the present invention and from the ensuing description and accompanying drawings.

Abbreviations

CD Compact Disc

DVD Digital Video Disc

DSL Digital Subscriber Line

DL Downloader

FPR First Payment Receiver

SPR Second Payment Receiver

Drawings—Reference Numerals

20—Copyright Holder

30—Copyright Holder

40—Indefinite Number of Copyright Holders

42—File Containing Copyrighted Content

43—File Containing Copyrighted Content

44—File Containing Copyrighted Content

50—Consensus of Value of Copyrights by Type and Category

60—Contract Between First and Second Payment Receivers

70—First Compensatory Payment Receiver

80—Second Payment Receiver

90—Downloader

93—File-Sharing Service

95—The Internet

### DRAWINGS

Figs

FIG. 1 shows a block diagram of a download redemption system according to the invention.

FIGS. 2A, 2B and 2C show a block diagram of the events and progression of the present redemption system.

### SUMMARY

The present invention is based on the relationship between, and the sequence of actions performed by three component parties, which are as follows: In random order, the first party is Downloader [DL]: This is an individual or individuals, representing a computer terminal and its storage medium(s). DL downloads a file(s), that contains copyrighted content, by typing in its given name and clicking on it. Normally such content is a song or a motion picture, either of which has been digitized and stored as a file having a title. The source of the named file(s) is any storage medium which is accessible via the Internet.

The second party is the First Payment Receiver [FPR]: This party is an entity or company represented by a data processing system and in most cases a website. FPR 70 receives a “first compensatory payment” which is charged to, or withdrawn from, DL. Prior to the first compensatory payment being made, a payment amount is arrived at by FPR. The payment is assessed following the act of downloading which is being compensated for with the first payment.

The third party is the Second Payment Reception [SPR]: This party is a copyright holder or its representative. FPR arranges, by creating a contract with one or more SPRs, for an amount which is to be paid by one or more DLs according to the number of file(s) acquired, and the category of file(s) downloaded by DL. Files containing songs or motion pictures will fall into varying, predetermined, price categories, based on their demand. DL, using the Internet, is able to request an electronic search for a file(s) by entering a lingual term(s), such as the title of a song and its performer or the title of a motion picture, into a “file-sharing service”, and as a result is able to access any number of requested file(s). DL then by simply clicking on one of the requested, and accessed files, downloads the chosen file(s) in a manner which, when implemented without the present invention, is considered to be a civil infraction and illegal in many jurisdictions. According to the invention, DL becomes registered with an entity which is a payment reception service. The payment reception service uses various means to acquire an inventory of files downloaded by DL, then DL pays a determinable amount (predetermined by a consensus of copyright holders), which alleviates any illegality and/or civil wrongdoing which would exist without the present system.

### DETAILED DESCRIPTION

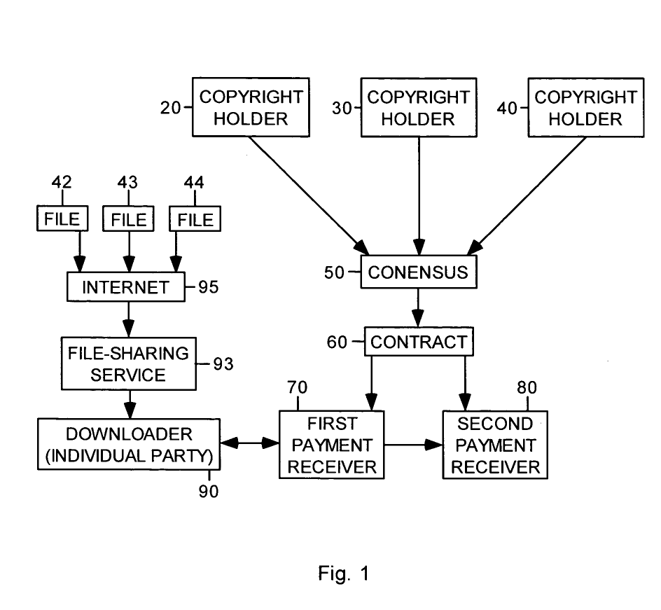

Preferred Embodiment—Voluntary Participation by Downloader—Sequence of Events Involving the Components of FIG. 1

FIG. 1, including its directional arrows, shows the juxtaposition of each of the components and parties involved in the process. A plurality of Copyright Holders 20, 30, and 40 determine values for various categories of files which contain copyrighted content, for example, songs or motion pictures. Such files are downloaded by DL 90. Copyright holders are the writer or author of the copyright or the legal representative of the copyright. DL 90 is any individual party who engages in downloading through file-sharing through The Internet. The determination of any copyright value is termed a Consensus (block 50). A First Payment Receiver [FPR] 70 creates a Contract 60 with a Second Payment Receiver [SPR] 80. An FPR 70 provides a billing system similarly to a phone company, which reviews previous activity and bills accordingly. Contract 60 includes reference to at least one Consensus 50.

At a time which precedes the process of FPR 70 billing DL 90 for one or more acts of downloading, DL 90 uses a File-Sharing Service 93 to download from a storage area (not shown) on a site (not indicated) on Internet 95, files containing copyrighted content. Such files are represented by blocks 42, 43, and 44. Once the billing process and the reception by FPR 70 of a first compensatory payment from DL 90 have occurred, FPR 70 incurs a debt to SPR 80.

Registration—FIG. 1

In the preferred embodiment, DL 90 exercises the option of registering with FPR 70 (in most cases) prior to downloading any files so that FPR 70 will bill DL 90 for one or more acts of downloading. The billing for downloading occurs at a time after the downloading occurs.

As part of registration, DL 90 supplies at least one item of identifying information to FPR 70 which is then stored in a data analysis system within a response processing system (known but not shown). Such information includes the identity of DL 90 and usually includes a chosen user name and password (known but not shown). The arrow originating from block 90 which extends to block 70 not only represents a first compensatory payment, but also represents the act of registration by DL 90.

DL 90 may expedite registration for this embodiment, by having a previous registration resulting from receiving another product or service provided by FPR 70 or its affiliate (block 205). Such a product or service may be licensed software, or a service such as cable line, telephone, subscription television, or Internet (including DSL) 95. In another instance where FPR 70 has an affiliate, the affiliate is a File-Sharing Service 93 which is being used by DL 90 to download files containing copyrighted content. When DL 90 and File-Sharing Service 93 are the same, the two parties are considered affiliates, based on their providing dual services.

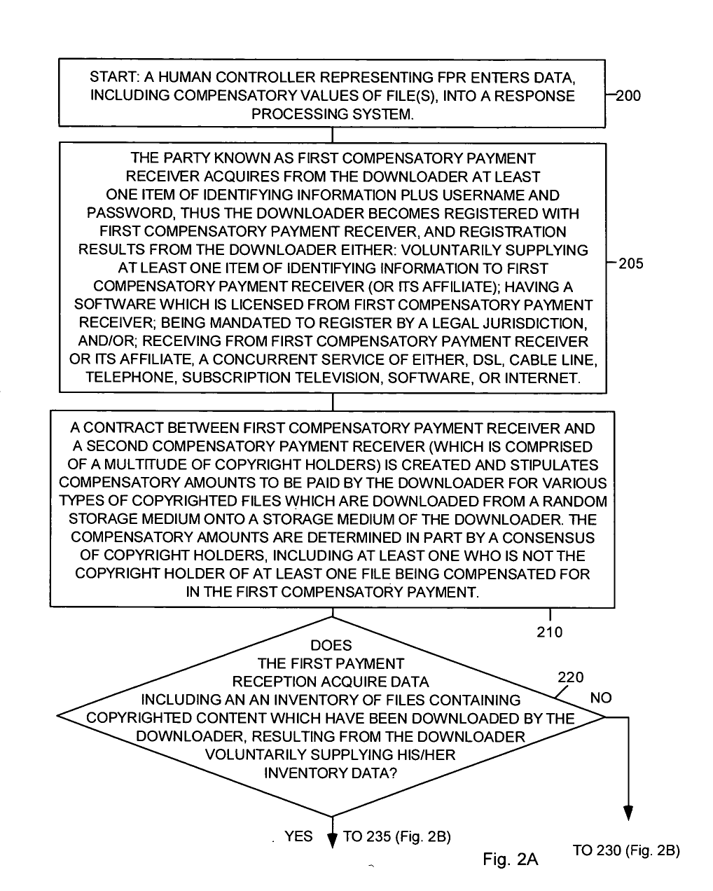

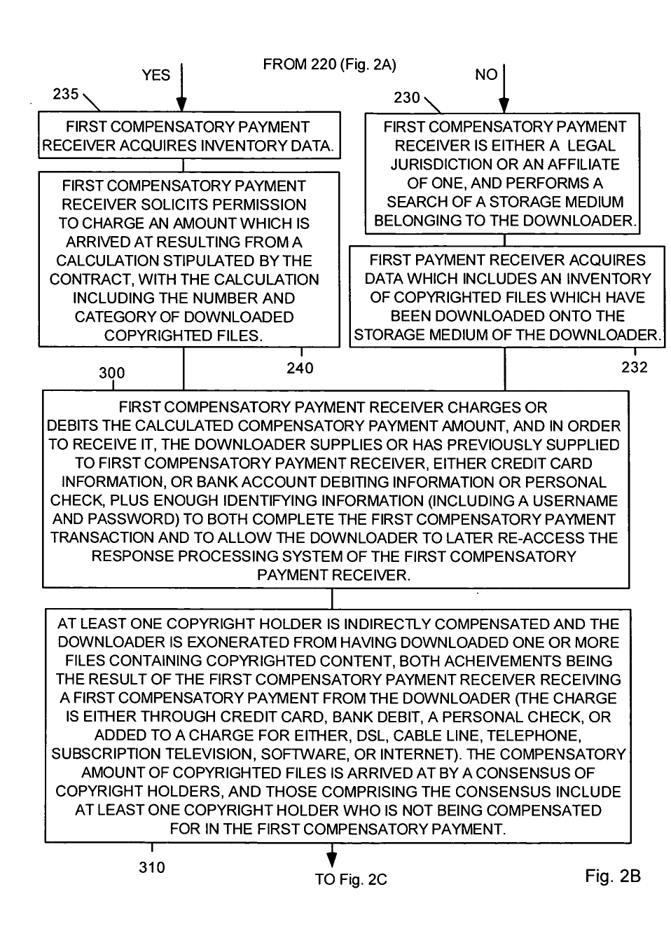

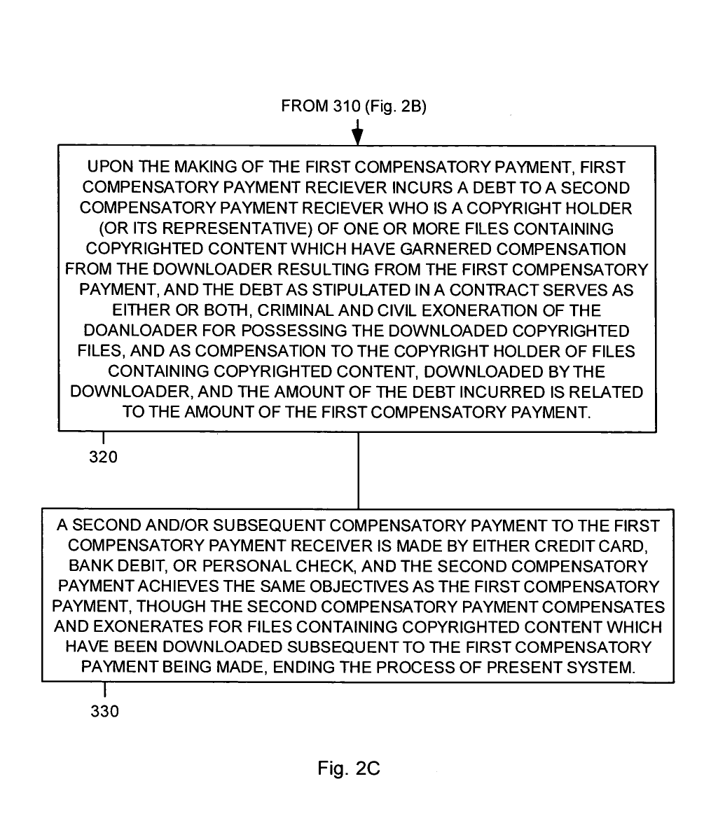

The Acquisition of Inventory Data Billing Process and Reception of First Compensatory Payment—FIGS. 2A and 2B

FIGS. 2A and 2B show FPR 70 acquiring data from DL 90 which includes an itemization of the files which have been downloaded by DL 90. FPR 70 then bills DL 90, and then receives payment from DL 90. In more detail the sequence is as follows: DL 90 volunteers the data which is used to determine the amount by which DL 90 is to be billed of DL 90. Such data includes the number of, and category/type of, files and/or their value determined by Consensus 50 and as stated in Contract 60. As indicated in block 220 (FIG. 2A), DL 90 may volunteer data. This includes DL 90 allowing FPR 70 to use an Internet connection to employ an algorithm which scans a memory in a computer of DL 90, to acquire inventory data to create a roster of one or more files which have been downloaded by DL 90 (block 235). Alternatively, the volunteering of inventory data by DL 90 to FPR 70 may occur from DL 90 presenting the data to FPR 70 in the form of either a multiple-choice response or a written email. Included in the definition of a memory is any designated area of a memory, such as a specific file or filing area of a computer.

Having acquired the inventory data, FPR 70 then requests and receives permission to charge DL 90 a calculated amount which reflects the acquired inventory data (block 240). DL 90 sends a first compensatory payment to FPR 70 who then receives it from DL 90 in the form of charge, bank debit, or a check sent through the mail. Although the first compensatory payment is made to an entity which is not the actual copyright holder(s) of the file(s) being paid/compensated for, the first compensatory payment constitutes an indirect payment to at least one copyright holder.

Debt Incurred By First Payment Receiver And Exoneration of Downloader—FIG. 2C

As shown in block 320, when DL 90 makes a first compensatory payment to FPR 70, a debt is incurred by FPR 70 to SPR 80. As previously mentioned, SPR 80 is a copyright holder (or its representative). Also as mentioned, the amount of the debt is related to Contract 60 and Consensus 50.

Also shown in block 320, as a result of participation, and specifically by making a first compensatory payment, DL 90 is exonerated from criminal and civil copyright liability for the files which were compensated for in the first compensatory payment. The exoneration occurs in part because FPR 70 incurred the debt to SPR 80 upon receiving the first compensatory payment.

In some instances, FPR 70 may increase incentive for voluntary registration of DL 90 by offering a discount for a goods or service supplied to DL 90 by FPR 70 or its affiliate.

Thus by attaching a payment option to non-payment prior art systems (which retrieve files from the Internet), DL 90 can compensate copyright holders of such downloaded files. This combination of elements also overcomes the disadvantage of pay sites which compensate copyright holders, but which don't allow searches of the entire Internet.

Operation—Preferred Embodiment

DL 90 voluntarily registers with FPR 70 (block 205). DL 90 then registers to make certain data available to FPR 70. This data includes the inventory of files containing copyrighted content, previously downloaded by DL 90. FPR 70 may acquire data by using an algorithm which performs via the Internet, a scanning of one or more memories of a computer of DL 90. Also, DL 90 may present such inventory data to FPR 70. This occurs when DL 90 responds to a multiple-choice grid, or lists the data in a written email. FPR 70 then refers to Contract 60 to calculate an amount to be charged to DL 90, and notifies DL 90 of the amount. DL 90 agrees and then makes a payment in the form of either a credit card charge, bank debit/transfer, or a check sent through the mail, completing a first compensatory payment (block 300).

FPR 70 receives from DL 90 a first compensatory payment (block 310). Coinciding with the reception of the first compensatory payment, FPR 70 incurs a debt to SPR 80 in an amount related to, and indicative of, the first compensatory payment. Because it is assumed by DL 90, FRR 70, and SPR 80 that FPR 70 will pay its debt to SPR 80, DL 90 indirectly compensates SPR 80 by making the first compensatory payment (block 320). The word “indirectly” is used to indicate that once a first compensatory amount is received from DL 90, the responsibility of completing the process of compensating the copyright holders now rests with FPR 70 and is currently in the form of an incurred debt. In some instances, when the first compensatory payment is made, at least one copyright holder which is not a participant of the Consensus 50 group of copyright holders (but instead is represented by the group of copyright holders which created Consensus 50) is indirectly compensated. DL 90 is exonerated civilly and criminally.

A personalized example of the preferred embodiment is as follows: Assume that FPR 70 is a service entitled, “Filefee.” Filefee signs a contract with the Recording Industry Association of America [RIAA]. Assume that DL 90 is John Doe, an individual who either a) has been illegally downloading copyrighted files, or b) now intends to legally download copyrighted files by utilizing Filefee. Doe registers with Filefee (block 205). He then uses a File-Sharing Service 93 to download files (block 42, 43, or 44) which contain copyrighted material. File-Sharing Service 93 may or may not be a component of Filefee, and whether it is or not has no bearing on the method or objectives of the invention.

After a billing period passes, Filefee uses its software, as represented by the arrow originating at block 70 and extending to block 90, to scan via the Internet, the hard drive of Doe's computer. Filefee then makes an accounting of the number and type(s) of files Doe has downloaded and subsequently bills John in an amount related to the results of the scan (block 240). John pays the amount billed (block 90 to block 70). Filefee then incurs a debt (proportionate to the amount received from Doe) to the copyright holders which own (or control) the copyrights of the files downloaded by Doe (block 70 to block 80).

The following is another example, and is one which differs from the previous in the method which FPR 70 uses to acquire the data regarding files downloaded by DL 90. This scenario occurs when the File-Sharing Service and Filefee are either affiliated or are one in the same: Rather than Filefee using scanning software at the end of a billing period in order to measure Doe's downloading activity, and then billing Doe for his downloading activity during the billing period, Filefee tracks Doe's downloads one by one, as they take place, and then bills Doe for his downloads which took place during the billing period (block 300).

Description—Alternative Embodiment—Registration/Participation Mandated by a Jurisdiction.

As with the preferred embodiment, a Contract 60 (including at least one Consensus 50) is created between FPR 70 and SPR 80. FPR 70 may or may not be a governing body. If not, FPR 70 is working in conjunction with a governing body (block 230), for the purpose of both facilitating compensation to SPR 80 (block 310) and also, as mentioned, to facilitate exoneration of DL 90 from the downloading of copyrighted files (block 320).

Registration—FIG. 1

The process and methods available for DL 90 to become registered are the same as those in the preferred embodiment. I.e., DL 90 supplies to FPR 70 at least one item of identifying information which is then stored in a data analysis or response processing system. Such information is normally the name of DL 90 and usually also includes their chosen user name and password. As indicated in FIG. 1, the arrow originating from the block 90 which extends to block 70 not only represents a first compensatory payment (as previously indicated), but also represents the act of registration. DL 90 may expedite registration for the process of this embodiment, resulting from having a previous registration by receiving another product or service provided by FPR 70 or its affiliate (block 205).

The Acquisition of Inventory Data, the Billing Process, and Reception of First Compensatory Payment—FIGS. 2A and 2B

As in the preferred embodiment, the billing occurs at a time after downloading. Prior to billing, at least one storage medium of DL 90 is inventoried by FPR 70, most often algorithmically. This refers to an automated data scanning and retrieval software system which travels via the Internet, and scans the memory of DL 90. A retrieved inventory of downloaded files is then logged into the response processing system of FPR 70 (block 232). Then with or without permission of DL 90, FPR 70 either charges a monetary amount (directly or through a billing process), withdrawals a monetary amount, or combines a monetary charge to an existing bill for a product or a service concurrently provided by FPR 70 or its affiliate. This is done in the manner previously described (block 310), from DL 90 in the first compensatory payment.

Debt Incurred by First Payment Receiver, and Exoneration of Downloader—FIG. 2C

As shown in block 320, after FPR 70 receives a first compensatory payment from DL 90, a debt is incurred by FPR 70 to SPR 80. As previously mentioned, SPR 80 is a copyright holder (or its representative). Also as mentioned, the amount of the debt is related to Contract 60, and specifically, to Consensus 50.

Also shown in block 320, as a result of cooperation, and specifically after making a first compensatory payment, DL 90 is exonerated from criminal and civil liability for the files which were compensated for in the first compensatory payment. The exoneration occurs because FPR 70 incurs a debt to SPR 80 upon receiving the first compensatory payment.

Operation—Alternative Embodiment

In this alternative embodiment, DL 90 registers, or is registered with FPR 70 (block 205). A contract is (or has been) created between FPR 70 and SPR 80 stipulating the monetary amounts, which if paid by DL 90 serve to criminally and/or civilly exonerate DL 90 (relative to downloading onto a storage medium files which contain copyrighted content), and also to compensate the appropriate copyright holder(s) (block 210). A storage medium, normally the hard-drive, of DL 90 is inventoried by FPR 70, most often algorithmically via an Internet connection, as to the files containing copyrighted content which have been downloaded (block 232). FPR 70 calculates an amount to be charged, and either receives payment from DL 90 in either of the forms previously discussed, or notifies DL 90 of an intended charge. The amount is related to the number of file(s), and their categories (block 240). In the event DL 90 agrees on the amount (block 300), and the amount is then received by FPR 70 (block 310). In charging a first compensatory payment to DL 90, FPR 70 incurs a debt to SPR 80 in an amount indicative of the first compensatory payment (block 320). As mentioned, because it is assumed that FPR 70 will pay its debt to SPR 80, DL 90 indirectly compensates SPR 80 in making the first compensatory payment (block 310).

In a more detailed example of the alternative embodiment, assume that Filefee, which is an affiliate of the federal government, or a subsidiary jurisdiction, signs a contract with the RIAA. John Doe has been using a free File-Sharing Service 93 to illegally download copyrighted files (blocks 42, 43, and 44 are extracted using a File-Sharing Service 93). Filefee becomes aware of John's downloading actions. Doe is specifically and legally mandated to register with Filefee, and hence does so. After a billing period passes, Filefee uses its Internet software to scan the hard-drive of Doe's computer (block 232) and make an accounting of the number and type of files Doe has downloaded. Filefee then bills Doe in an amount determined by the results of the scan (block 300). Doe pays the (first compensatory payment) amount billed to him. Filefee then incurs a debt (relative to the amount received from John) to the copyright holders which own (or control) the copyrights of the files downloaded by Doe (block 320).

Filefee (FPR 70) receives a first compensatory payment from Doe (DL 90). A debt related to the Contract 60 and its Consensus 50, is incurred to the appropriate copyright representative (SPR 80). Doe is thereby exonerated.

Conclusion, Ramifications, and Scope

It is thus seen that the present system provides novel methods for copyright holders to be compensated for their works. Additionally, those individuals who engage in downloading of copyrighted files located by title, through a file-sharing service can use the present system to become exonerated from criminal or civil wrongdoing. Further, downloader is able to download a copyrighted file without having to execute the time-consuming prior steps otherwise required to make a specified purchase of each individual file, as is the protocol in making a “registered purchase” of a file from a “legitimate” or “legal” service other than with the present system.

Although the above description contains specific examples, many variations and ramifications are possible. For example, a company not previously involved in the music or film industry, but one with experience in billing customers periodically, such as a phone company, can easily formulate a billing system using the present system, and enter the music or film industry by means of receiving revenues as a third party. Alternatively, a company with previous experience in the music or film industry can use a phone company billing system as a template for billing individuals who engage in downloading of song or motion picture files.

While much specificity is made throughout the above description, and some elements are employed which are known to those skilled in the art, it combines these elements in a novel way which produces new results heretofore undiscovered. The scope of this invention should be determined, not by the embodiments illustrated, but by the appended claims and their legal equivalents.

1. A method for an entity to allow an individual to make a compensatory payment in return for said individual using a file-sharing service to download of one or more files containing copyrighted content, comprising in o:
a) creating a contract between an entity and a second payment receiver, said entity being identified as a first payment receiver,
b) obtaining a registration from an individual, said registration including at least one item of identifying information of said individual, said at least one item of identifying information being used by said entity to identify files containing copyrighted content which have been downloaded by said individual, said identifying information also being used to contact said individual,
c), assigning a monetary amount to at least one category of file containing copyrighted content,
c) charging said individual said monetary amount in return for said individual previously downloading one or more files containing copyrighted content, and
d) receiving from said individual said monetary amount, said monetary amount constituting a compensatory payment for said at least one file containing copyrighted content, said compensatory payment exonerating said individual from liability related to said downloaded file.

2. The method of claim 1 wherein said file-sharing service and said first payment receiver are the same entity.

3. The method of claim 1 wherein said obtaining a registration from said individual occurs when said individual receives a service from a selection from the class consisting of said entity and an affiliate of said entity, said concurrent service being selected from the class consisting of telephone, subscription television, and Internet, said Internet including cable line, and DSL.

4. The method of claim 1 wherein said entity incurs a debt to a second entity caused by first entity receiving said compensatory payment, said second entity being a copyright holder of said one or more files which have been downloaded by said individual,
said debt being owed to a first copyright holder, further including said first copyright holder of said file containing copyrighted content is not among said plurality of copyright holders.

5. The method of claim 1, further including said entity controlling an algorithm to obtain said data from said individual, said algorithm emanating from a memory at a first location, to scan a memory controlled by said individual, said memory of said individual being at a second location, said first and second locations being connected via the Internet, and wherein said scan results in a determination of the number of files containing copyrighted content having been downloaded onto said memory of said individual.

6. The method of claim 1 wherein the steps of claim 1 are performed in the order which they are listed.

6. The method of claim 1, further including said individual providing a user name and password during said registration, so that said first compensatory payment is expedited by said individual providing said user name and password.

7. A method for a first compensatory payment receiver to allow an individual party to indirectly compensate at least one copyright holder of copyrighted content which exists within an electronic file, said electronic file having been downloaded from a first storage medium not represented by said at least one copyright holder to a second storage medium not represented by said at least one copyright holder wherein said second storage medium belongs to said individual party, further including said individual party receiving exoneration from a civil and criminal liability, comprised of:
(a) creating a contract with a group of copyright holders, said contract including at least one consensus, said at least one consensus including a first monetary amount which when charged of an individual party, constitutes permission by said group of copyright holders for said individual party to possess on a storage medium one or more files containing digitized content having a copyright held by at least one copyright holder being represented by said group of copyright holders wherein the acquiring of said one or more files containing digitized content having a copyright held by at least one copyright holder being represented by said group of copyright holders is resulting from downloading from a first memory storage not represented by said group of at least one copyright holders to a second memory storage not represented by said group of copyright holders, further including said second memory storage belonging to said individual party,
(b) registering said individual party to participate in a payment process which allows said individual party to indirectly compensate at least one copyright holder being represented by said group of copyright holders in return for said individual party acquiring one or more files containing digitized content having a copyright held by said at least one copyright holder being represented by said group of copyright holders wherein said acquiring one or more files containing digitized content having a copyright held by said at least one copyright holder being represented by said group of copyright holders is resulting from downloading from a first memory storage not represented by said at least one copyright holder being represented by said group of copyright holders to a second memory storage not represented by said at least one copyright holder being represented by said group of copyright holders further including said second memory storage belonging to said individual party,
(c) acquiring data from said individual party, said data including an inventory of one or more files containing copyrighted content which has been downloaded from a first storage medium not representing said at least one copyright holder being represented by said group of copyright holders to said second storage medium not representing said at least one copyright holder being represented by said group of copyright holders further including said second storage medium belonging to said individual party,
(d) receiving from said individual party said first compensatory payment via a selection from the class consisting of a credit card transaction, a bank account debit, a personal check, and an amount being added to a bill for a concurrent service provided to said individual party by said first compensatory payment receiver, said concurrent service being a selection from the class consisting of DSL, cable line, telephone, subscription television, software, and Internet, further including said receiving of said first compensatory amount exonerating said individual party from a civil and criminal liability, and
(e) incurring a monetary debt to a second compensatory payment receiver, said second compensatory payment receiver representing at least one copyright holder of one or more files which have been downloaded from a first memory storage not represented by said at least one copyright holder to a second memory storage not represented by said at least one copyright holder further including said second memory storage belonging to said individual party.

7. The method of claim 6, further including said registering including said first compensatory payment receiver acquiring from said individual party and storing in a data analysis system at least one item of identifying information, said data analysis system being a component of a response processing system, further including said user name and password being used to expedite said individual repeating steps a), c), and d) of this claim on a subsequent date to achieve the method desc.

8. A response processing system which represents a first payment receiver said first payment receiver representing a plurality of copyright holders, comprising:
(a) a software program which records an inventory selected from the class consisting of one or more files while said one or more files are being downloaded onto a storage medium of an individual party and, and one or more files which have previously been downloaded onto a storage medium of said individual party,
(b) a connection link from said storage medium of said individual party to said processing system, said processing system and said storage medium being connected via the Internet,
(c) a data analysis system which analyzes said one or more files which have been downloaded onto a storage medium of said individual party, said data analysis system being arranged to:
(1) recognize a storage medium of said individual party, said individual being previously registered with said data analysis system,
(2) retrieve data from a storage medium of said individual party, said data having been retrieved identifying said one or more files which have been downloaded onto a storage medium of said individual party, and
(3) use previously stored data including a first monetary amount to calculate the amount of a first compensatory payment to be received by said first payment receiver from said individual party.

9. The method of claim 8 further including said data analysis system using previously stored data including the amount of said first compensatory payment to calculate the amount of a second compensatory payment to be made from said first payment receiver to a second payment receiver.

9. The method of claim 8, further including said response processing system accepting a credit card payment whereby said individual has previously supplied his or her credit card number and month of expiration of said credit card.
